(19) United States
(12) Patent Application Publication
(10) Pub. No.: US 2013/0113197 A1
(43) Pub. Date: May 9, 2013

(54) TRANSAXLE ASSEMBLY FOR MOUNTING DIRECT DRIVE AXLES TO A BACKBONE FRAME

(71) Applicant: Leo P Oriet, Rochester Hills, MI (US)

(72) Inventor: Leo P Oriet, Rochester Hills, MI (US)

(73) Assignee: NAVISTAR CANADA, INC., Lisle, IL (US)

(21) Appl. No.: 13/810,706

(22) PCT Filed: Jul. 23, 2010
(86) PCT No.: PCT/US10/43085

§ 371 Date: Jan. 17, 2013

(51) Int. Cl. B60G 7/02

(52) U.S. Cl. CPC B60G 7/02
USPC 280/786

(57) ABSTRACT

A transaxle assembly (32) for mounting a drive axle assembly (38) to a vehicle backbone frame (36) includes a suspension body (18) having a receiving cavity (19) for receiving the backbone frame, and a plurality of frame members (4, 5, 9, 10) disposed generally transversely to the suspension body. The plurality of frame members (4, 5, 9, 10) are pivotally attached to the suspension body (18) at an upper end (44) of the frame members. The transaxle assembly (32) also includes a receiving structure (12) that receives the plurality of frame members at a lower end (45) of the frame members (4, 5, 9, 10). The receiving structure (12) has a receiving hole (13) that is generally parallel with the backbone frame for receiving the drive axle assembly (38). A cylinder (6, 7) extends between the suspension body (18) and the receiving structure (12).

### BACKGROUND

Embodiments described herein relate to mounting direct drive axles to vehicle frames, and particularly, to a transaxle assembly for mounting direct drive axles to a vehicle backbone frame.

Typically, truck, bus, coach, military and other commercial vehicles have a frame assembly formed of two longitudinal frame rails joined together with a plurality of cross members. The central portion of the frame is generally an open structure devoid of cross members, which allows the frame to twist longitudinally, providing torsional compliance as the vehicle traverses over uneven surfaces.

Rigid dual wheel drive axles are attached to a rear end of the frame rails using a variety of suspension systems. One or more drive axles are utilized to transfer the rotational energy generated by a conventional diesel engine into vehicular motion.

Although the conventional frame assembly is well balanced, equally spreading the load through the two frame rails, commercial vehicles are subjected to significant frame twisting in service. With the prior art frame assemblies, when the vehicle travels over an uneven surface, the suspension transfers the torsion into frame mounted parts such as fuel tanks, known as “fuel tank walking”, in which over the passage of time, the fuel tank moves along the frame rails, commonly resulting in misalignment of a fuel fill tube with a fuel fill door. Other components that absorb the torsion are the rigid truck cab structure and the front hood, which due to the torsional absorption, can experience micro fractures and hinge breakage in the field.

Further, under the torsional loading in the field, the frame rails can crack and/or split, and the transverse torque rods can break and/or be forced through the frame rail. When failures of this nature occur, the broken frame rails are repaired or replaced. Repairs often entail the complete disassembling of the frame assembly and cross members, cutting all huck bolts and then inserting a fabricated frame rail shaped such that it can be inserted along the inside surface of the previously broken rail. However, there is service downtime to repair and/or replace failed components, and the repaired/replaced frame assembly remains unable to absorb the longitudinal torsion.

Additionally, there is interest in the industry to electrify commercial vehicles. The electrification of commercial vehicles provides new opportunities to incorporate alternative drivelines and suspensions into commercial vehicles. However, even with the development of electrified commercial vehicles, the prior art frame assemblies do not address the issue of torsional loading.

### SUMMARY

A transaxle assembly for mounting a drive axle assembly to a vehicle backbone frame includes a suspension body having a receiving cavity for receiving the backbone frame, and a plurality of frame members disposed generally transversely to the suspension body. The plurality of frame members are pivotally attached to the suspension body at an upper end of the frame members. The transaxle assembly also includes a receiving structure that receives the plurality of frame members at a lower end of the frame members. The receiving structure has a receiving hole that is generally parallel with the backbone frame for receiving the drive axle assembly. A cylinder extends between the suspension body and the receiving structure.

Another transaxle assembly for mounting two drive axle assemblies to a vehicle backbone frame includes a tubular-shaped suspension body having a receiving cavity for receiving the backbone frame, and two upper sub-frame members disposed generally transversely to the suspension body. One upper sub-frame member is disposed on each side of the backbone frame, and the upper sub-frame members are pivotally attached to the suspension body at upper ends of the upper sub-frame members. Two lower sub-frame members are disposed generally transversely to the suspension body, with one lower sub-frame member on each side of the backbone frame. The lower sub-frame members are disposed under each upper sub-frame member, and the lower sub-frame members are pivotally attached to the suspension body at upper ends of the lower sub-frame members. The assembly also includes a first receiving structure receiving one upper sub-frame member and one lower sub-frame member at a lower end of each sub-frame member, and a second receiving structure receiving the other upper sub-frame member and the other lower sub-frame member at a lower end of each other sub-frame member. Each receiving structure has a receiving hole that is generally parallel with the backbone frame for receiving the two drive axle assemblies, and each receiving structure is pivotal about the backbone frame. The assembly also includes a first cylinder extending between the suspension body and the first receiving structure, and is disposed between the upper ends of one of the two upper sub-frame members, and a second cylinder extending between the suspension body and the second receiving structure, and is disposed between upper ends of the second of the two upper sub-frame members.

A transaxle and drive axle assembly attachable to a backbone frame includes a suspension body having a receiving cavity for receiving the backbone frame, and a plurality of frame members disposed generally transversely to the suspension body. The plurality of frame members are pivotally attached to the suspension body at an upper end of the frame members. A receiving structure receives the plurality of frame members at a lower end of the frame members. The receiving structure has a receiving hole that is generally parallel with the backbone frame. A cylinder extends between the suspension body and the receiving structure. A drive axle assembly extends through the receiving structure at the receiving hole. Four wheels are attached to the drive axle assembly, where the four wheels are disposed on one side of the backbone frame.

### BRIEF DESCRIPTION OF THE DRAWINGS

FIG. 1 is a top view of a transaxle assembly for mounting a drive axle to a backbone frame.

FIG. 2 is a front view of the transaxle assembly.

### DETAILED DESCRIPTION

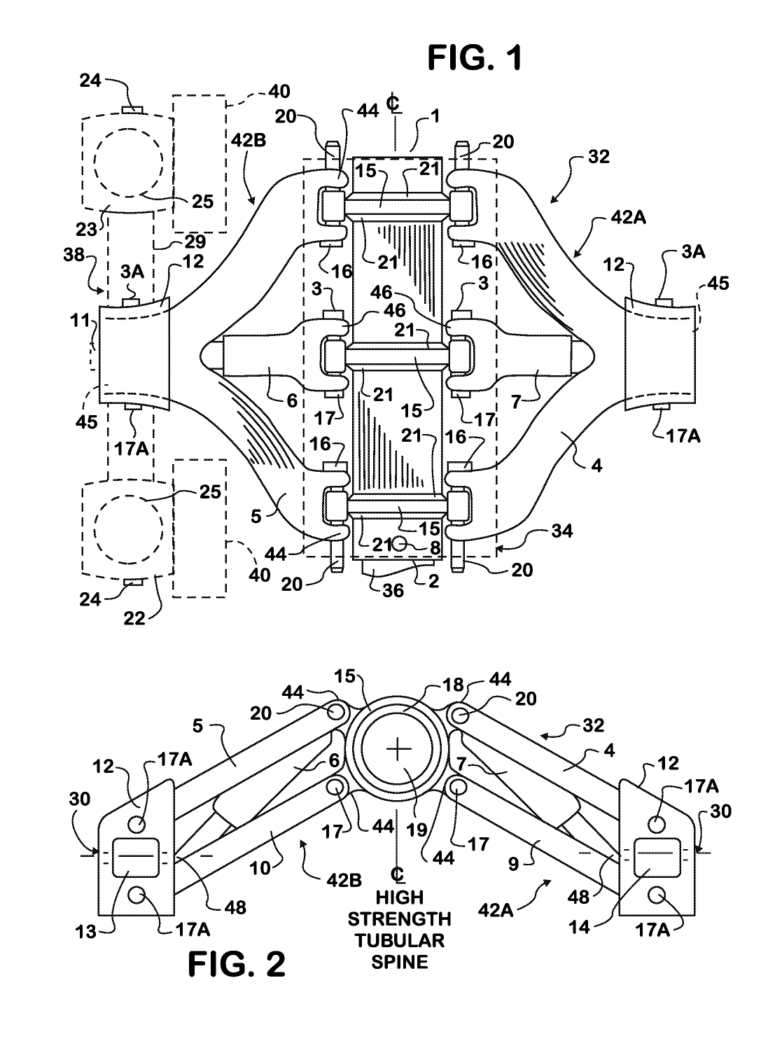

Referring now to FIG. 1 and FIG. 2, a transaxle assembly for a vehicle trailer is indicated generally at 32. The transaxle assembly 32 is attached to a fifth wheel 34 at a fifth wheel attachment location 20 with a plurality of pins 16 that transmit the acceleration and deceleration forces of the vehicle trailer to the fifth wheel. The transaxle assembly 32 attaches a drive axle assembly 38 to a backbone frame 36, where the backbone frame defines the sagittal plane or centerline of the transaxle assembly 32 and the vehicle.

The transaxle assembly 32 receives the backbone frame 36 generally centrally and generally perpendicularly through the transaxle at a backbone receiving cavity 19. The backbone frame 36 may be a light-weight, high strength tubular steel, structural composite or any other structural material frame. The backbone frame 36 is received in the generally cylindrical receiving cavity 19, however other configurations are possible. Further, while a single transaxle assembly 32 is shown, multiple transaxle assemblies may be positioned along the length of the backbone frame 36. The tractor's backbone frame 36 is received into the receiving cavity 19, for example by sliding the frame into a front end 1 until the backbone frame is exposed at a rear end 2, and the position of the frame is locked with respect to the transaxle assembly 32 with a pin 8.

Each transaxle assembly 32 is configured for mounting the drive axle assembly 38, such as an independent dual wheel direct drive axle (shown in phantom) to the backbone frame 36, however it is possible that the transaxle assembly 32 can be used with other types of drive axles and rear suspensions. Commonly assigned U.S. patent application Ser. No. ______, entitled Independent Dual Wheel Direct Drive Axles (Attorney Docket No. D6833) discusses an exemplary independent dual wheel direct drive axle assembly 38, and is incorporated herein in its entirety by this reference.

For example, the drive axle assembly 38 may have a front direct drive unit 23 and a rear direct drive unit 22 that are pivotally disposed on a spindle shaft 24, however other numbers of drive axles are contemplated. The drive axle assembly 38 may have a cushion ride suspension 25 and be attached to the transaxle assembly 32 with a walking beam 29. When the direct drive axle assembly 38 drives over an uneven driving surface, the direct drive axle assembly 38 independently oscillates with respect to the backbone frame 36 so that the wheels 40 encountering the uneven driving surface can traverse the surface, while the wheels not encountering the uneven driving surface remain in contact with the driving surface.

Further, while the left drive axle assembly 38 is shown in FIG. 1, it should be appreciated that a right direct drive axle assembly may be located opposite of the left drive axle assembly, the right direct drive axle assembly having a configuration that is generally the mirror-image of the left drive axle. The front and rear axles on the left drive axle assembly 38 oscillate independently of the oscillation of the front and rear axles on the right side. Together, the transaxle assembly 32 and the drive axle assembly 38 are attachable to the backbone frame 36 to provide independent oscillation from the left side to the right side of the backbone frame, and from the front set of wheels 40 to the rear set of wheels 40 associated with each transaxle assembly 38.

The transaxle assembly 32 includes a left sub-frame 42A and a right sub-frame 42B that are attached to a suspension body 18, which may be generally tubular-shaped. Each sub-frame 42A, 42B may have an upper frame member 4, 5 and a lower frame member 9, 10, where the frame members 4 and 5 are common parts, and where frame members 9 and 10 are common parts, however other configurations are possible. The upper frame members 4, 5 and the lower frame members 9, 10 may be generally clevis-shaped or Y-shaped, with upper ends 44 attached to the suspension tube 18, however other shapes are contemplated. The upper and lower frame members 4, 5, 9, 10 can be made of cast iron, compacted graphite iron, structural composite, manufactured steel or any other material that provides the structural strength and material properties for the vehicle service loads.

The suspension body 18 may be a high strength, light-weight steel tube with an inside diameter that is slightly larger than an outside diameter of the tractor backbone frame 36, however other configurations are possible. The sub-frames 42A, 42B, are pivotally attached to the suspension tube 18 with the hinge pins 16 and 17 at clevis hinges for the upper frame members 4, 5 and the lower frame members 9, 10 respectively. The pins 16 extend beyond the clevis and are used to attach to service loads, such as fifth wheel assemblies 34. Hinge rings 15 are concentrically attached to the suspension body 18, for example with welds 21, and receive the hinge pins 17.

Opposite the upper ends 44, lower ends 45 of the sub-frames 42A, 42B are received in a receiving structure 12 and pinned with pins 17A and lock nut 3A. The receiving structure 12 may be a box having a parallelogram-shape, however other configurations are possible. A receiving hole 13, 14 is disposed through the receiving structure 12 for receiving the direct drive axle assembly 38, for example the pivot of walking beam 29 is pinned in place with a king pin 11. In the receiving hole 13, 14, the walking beam 29 is generally parallel with the backbone frame 36.

Each sub-frame 42A, 42B may mount four wheels 40 to the backbone frame 36 on one side (left or right) of the frame. Each transaxle assembly 32 may mount eight wheels 40 to the backbone frame 36, generally with an even amount of wheels on each side (left and right) of the frame. It is possible that some vehicles may be equipped with two or more transaxle assemblies 32 on the extended backbone frame 36 with a one piece rigid architecture or a frame made of multiple piece members joined together with hinged articulation.

Cylinders 6, 7, for example hydraulic or pneumatic extendable cylinders, extend from the suspension body 18, generally centrally between the clevis-shaped upper frames 4, 5 to the receiving structure 12. A first end 46 of the cylinder 6, 7, attaches to a hinge ring 15 with hinge pins 17 and lock nuts 3, and a second end 48 of the cylinder attaches to the receiving structure 12 with pins 17A. The cylinders 6, 7 dampen the pivotal movement of the receiving structure 12 of the sub-frames 42A, 42B with respect to the backbone frame 36. The pivotal movement of the sub-frames 42A, 42B with respect to the suspension body 18 results in movement of the receiving structure 12, which accommodates the oscillation of the direct drive axle assemblies 38.

It is possible that the pressure in cylinder 6, 7 may be variably and electronically controlled by the operator while in motion. Higher pressure in the cylinder 6, 7 may be used to raise the overall height of the vehicle chassis to increase the articulation of the transaxle assembly 32 or to increase the clearance of the suspension system. Lower pressure in the cylinder 6, 7 may be used to increase the vehicle's aerodynamics for highway use. Further, the vehicle may be equipped with a control system, for example a push-button system, so that the operator may choose between settings, for example on-highway, off-highway, off-road and auto settings. The settings may control the levels of articulation, the vehicle height clearances, the direct drive acceleration response, the vehicle velocity limits, the steering ratios and the electronically controlled shock damping, among other settings.

The transaxle assembly 32 with the direct drive axle 38 provides three axes of articulation to traverse roadway obstructions. The first independent axis of oscillation is between each of the direct drive units 22, 23 about the axis created by pin of the spindle shaft 24 at (the left to right direction). The second independent axis of oscillation is about pin 11 at a drive axle axis of rotation 30 (the front to rear direction). The third independent axis of oscillation is sub-frame 42A, 42B of the transaxle assembly 32 about the backbone frame 36.

Each transaxle assembly 32 along the backbone frame 36 independently articulates as the vehicle traverses over uneven surfaces. Further, each sub-frame assembly 42A, 42B, independently articulates as each side of the vehicle traverses uneven surfaces. The transaxle assembly 32 reduces or eliminates the torsional loading on the backbone frame 36 by allowing the independent oscillation of the front and rear drive axles, as well as independent oscillation of the left and right drive axles. Further, the transaxle assembly 32 provides stability, continuous road contact, and balanced tire load spread and traction. Further still, the transaxle assembly 32 can be assembled and disassembled quickly, potentially reducing vehicle service downtime.

What is claimed is:

1. A transaxle assembly for mounting a drive axle assembly to a vehicle backbone frame, comprising:
a suspension body having a receiving cavity for receiving the backbone frame;
a plurality of frame members disposed generally transversely to the suspension body, the plurality of frame members pivotally attached to the suspension body at an upper end of the frame members;
a receiving structure receiving the plurality of frame members at a lower end of the frame members, the receiving structure having a receiving hole that is generally parallel with the backbone frame for receiving the drive axle assembly; and
a cylinder extending between the suspension body and the receiving structure.

2. The transaxle assembly of claim 1 wherein the suspension body is tubular-shaped.

3. The transaxle assembly of claim 1 wherein the receiving hole is configured to receive a walking beam of the drive axle assembly.

4. The transaxle assembly of claim 1 wherein the plurality of frame members comprise an upper sub-frame member having a general Y-shape, and a lower sub-frame member having a general Y-shape.

5. The transaxle assembly of claim 4 wherein the upper sub-frame member and the lower sub-frame member are generally parallel.

6. The transaxle assembly of claim 4 wherein the plurality of frame members comprise a first upper sub-frame member and a first lower sub-frame member on a left side of the backbone frame, and a second upper sub-frame member and a second lower sub-frame member on a right side of the backbone frame.

7. The transaxle assembly of claim 1 further comprising a plurality of hinge rings concentrically attached to the suspension body, wherein the frame members are attached to the hinge rings with pins.

8. The transaxle assembly of claim 1 further comprising a hinge ring concentrically attached to the suspension body, wherein the cylinder is attached to the hinge ring with a pin.

9. The transaxle assembly of claim 1 wherein the cylinder has variable pressure to increase the articulation of the transaxle assembly.

10. A transaxle assembly for mounting two drive axle assemblies to a vehicle backbone frame, comprising:
a tubular-shaped suspension body having a receiving cavity for receiving the backbone frame;
two upper sub-frame members disposed generally transversely to the suspension body, one upper sub-frame member on each side of the backbone frame, the upper sub-frame members pivotally attached to the suspension body at upper ends of the upper sub-frame members;
two lower sub-frame members disposed generally transversely to the suspension body, one lower sub-frame member on each side of the backbone frame and disposed under each upper sub-frame member, the lower sub-frame members pivotally attached to the suspension body at upper ends of the lower sub-frame members;
a first receiving structure receiving one upper sub-frame member and one lower sub-frame member at a lower end of each sub-frame member, and a second receiving structure receiving the other upper sub-frame member and the other lower sub-frame member at a lower end of each sub-frame member, each receiving structure having a receiving hole that is generally parallel with the backbone frame for receiving the two drive axle assemblies, wherein each receiving structure is pivotal about the backbone frame;
a first cylinder extending between the suspension body and the first receiving structure and disposed between the upper ends of one of the two upper sub-frame members; and
a second cylinder extending between the suspension body and the second receiving structure and disposed between upper ends of the second of the two upper sub-frame members.

11. The transaxle assembly of claim 10 wherein the receiving hole is configured to receive a walking beam of the drive axle assemblies.

12. The transaxle assembly of claim 10 wherein the two upper sub-frame members have a general Y-shape, and the two lower sub-frame members have a general Y-shape.

13. The transaxle assembly of claim 10 wherein at least one of the upper sub-frame members and at least one of the lower sub-frame members are generally parallel.

14. The transaxle assembly of claim 10 further comprising a plurality of hinge rings concentrically attached to the suspension body, wherein the four sub-frame members are attached to the hinge rings with pins.

15. A transaxle and drive axle assembly attachable to a backbone frame, comprising:
a suspension body having a receiving cavity for receiving the backbone frame;
a plurality of frame members disposed generally transversely to the suspension body, the plurality of frame members pivotally attached to the suspension body at an upper end of the frame members;
a receiving structure receiving the plurality of frame members at a lower end of the frame members, the receiving structure having a receiving hole that is generally parallel with the backbone frame;
a cylinder extending between the suspension body and the receiving structure; and
a drive axle assembly extending through the receiving structure at the receiving hole.

16. The transaxle and drive axle assembly of claim 15 wherein the plurality of frame members comprises two upper sub-frame members disposed generally transversely to the suspension body, one on each side of the backbone frame, the upper sub-frame members pivotally attached to the suspension body at upper ends of the upper sub-frame members, and two lower sub-frame members disposed generally transversely to the suspension body, one on each side of the backbone frame and disposed under each upper sub-frame, the lower sub-frame members pivotally attached to the suspension body at upper ends of the lower sub-frame members.

17. The transaxle and drive axle assembly of claim 16 wherein the receiving structure further comprises a first receiving structure receiving one upper sub-frame member and one lower sub-frame member at a lower end of each sub-frame member, and a second receiving structure receiving one upper sub-frame member and one lower sub-frame member at a lower end of each sub-frame member;

18. The transaxle and drive axle assembly of claim 15 wherein the cylinder comprises a first cylinder extending between the suspension body and the receiving structure and disposed between the upper ends of one of the two upper sub-frame members, and a second cylinder extending between the suspension body and the receiving structure and disposed between upper ends of the second of the two upper sub-frame members.

19. The transaxle and drive axle assembly of claim 15 wherein the drive axle is pivotable with respect to the transaxle at a drive axle axis of rotation.

20. The transaxle and drive axle assembly of claim 15 wherein the direct drive axle comprises first and second direct drive units that are pivotally disposed about a spindle shaft.
